(19) United States
(12) Patent Application Publication
(10) Pub. No.: US 2008/0049790 A1
(43) Pub. Date: Feb. 28, 2008

(54) System to Guide and Monitor the Installation and Revision of Network Cabling of an Active Jack Network System

(75) Inventor: Jack E. Caveney, Hinsdale, IL (US)

Correspondence Address: PANDUIT CORP., LEGAL DEPARTMENT - TP12, 17301 SOUTH RIDGELAND AVENUE, TINLEY PARK, IL, 60477, US

(73) Assignee: PANDUIT CORP., Tinley Park, IL (US)

(21) Appl. No.: 11/928,465

(22) Filed: Oct. 30, 2007

Related U.S. Application Data
(62) Division of application No. 10/969,863, filed on Oct. 22, 2004.
(60) Provisional application No. 60/513,705, filed on Oct. 23, 2003.

(51) Int. Cl. H04J 3/24

(52) U.S. Cl. 370/475

(57) ABSTRACT

Systems and methods for directing and facilitating the installation and revision of communications connections use indicators on active jacks to inform installers and revisors of installation and revision instructions forwarded by a network installation, monitoring, and/or revising system. Cross-connect and interconnect systems utilize patch panels populated with active jacks having indicators for facilitating installation and revision of cabling.

### CROSS-REFERENCE TO RELATED APPLICATION

This application is a divisional of U.S. patent application Ser. No. 10/969,863, filed Oct. 22, 2004, which claims priority to U.S. Provisional Application Ser. No. 60/513,705, filed Oct. 23, 2003, which is incorporated by reference in its entirety, as well as all materials incorporated therein by reference. This application incorporates by reference in its entirety U.S. patent application Ser. No. 10/439,716, entitled “Systems and Methods for Managing a Network,” filed May 16, 2003, as well as all materials incorporated therein by reference. Further, this application incorporates by reference in its entirety U.S. patent application Ser. No. 10/353,640, entitled “Systems and Methods for Documenting Networks with Electronic Modules,” filed Jan. 29, 2003, and all materials incorporated therein by reference, as well as U.S. patent application Ser. No. 10/366,093, entitled “VOIP Telephone Location System,” filed Feb. 13, 2003, and all materials incorporated therein by reference.

### BACKGROUND OF THE INVENTION

1. Field of Invention

Installation of communications cabling and maintenance of installed cable are complex processes, particularly when many connections must be installed or maintained. It is important that installation is accurate and that proper connections be maintained throughout the lifetime of a communications system.

2. Description of Related Art

The present invention is directed to systems and methods that facilitate both the installation of communications cabling and the maintenance and revising of installed cable.

### SUMMARY OF THE INVENTION

According to one embodiment of the present invention, systems and methods are provided by which a communications cable installer is provided with visual cues for proper installation of cabling.

According to another embodiment of the present invention, systems and methods are provided by which a communications system reviser is provided with visual cues for proper revision of installed cabling.

According to some embodiments of the present invention cabling installation and revision cues are provided by visual indicators on communications jacks.

According to some embodiments of the present invention cabling installation and revision cues are provided by visual indicators on a portable PC or other installation tool.

### BRIEF DESCRIPTION OF THE DRAWINGS

FIG. 1 is a plan view of a communications cable system;

FIG. 2 is a plan view of an active jack according to one embodiment of the present invention;

FIG. 3 is a plan view of another communications cable system;

FIG. 4 is a plan view of a portable PC connected to a network;

While the invention is susceptible to various modifications and alternative forms, specific embodiments are shown by way of example in the drawings and will be described in detail herein. However, it should be understood that the invention is not intended to be limited to the particular forms disclosed. Rather, the invention is to cover all modifications, equivalents, and alternatives falling within the spirit and scope of the invention as defined by the appended claims.

### DETAILED DESCRIPTION OF PREFERRED EMBODIMENTS

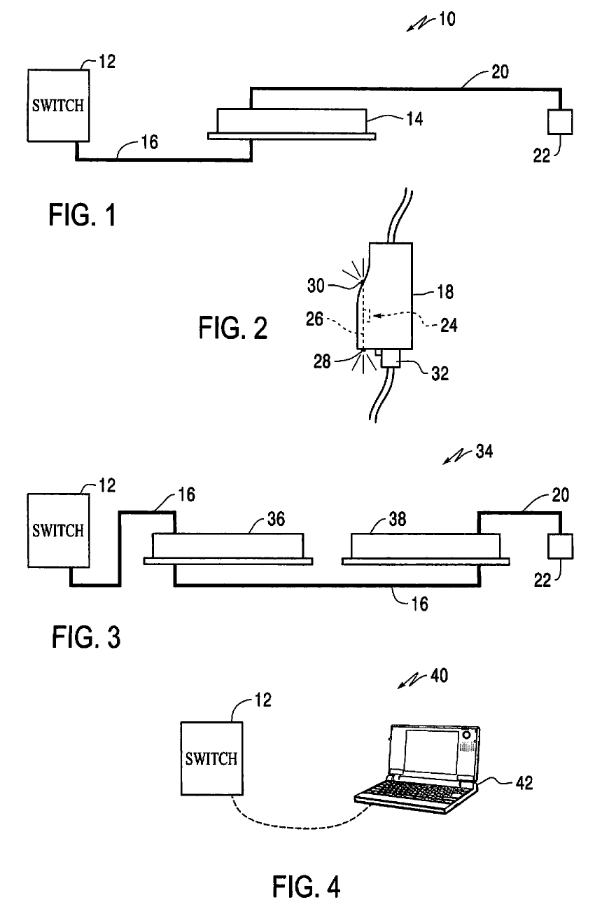

Turning now to FIG. 1, an interconnect cabling system 10 is shown. A switch 12 is connected to other network components via a network connection (not shown) and is connected to a patch panel 14 via a patch cord 16. The patch panel 14 comprises a number of active patch panel communication jacks 18, shown in FIG. 2 (which is a detail view of the circle “A” of FIG. 1). Horizontal cabling 20 connects the active communication jacks 18 of the patch panel 14 to an active communication jack 22, which in turn may be connected to a user device such as a computer or telephone (not shown). The active jacks shown in connection with the current invention may be active jacks of the type generally shown and described in U.S. patent application Ser. No. 10/439,716, attorney reference number 61982-00005, entitled “Systems and Methods for Managing a Network,” filed on May 16, 2003, which is incorporated herein by reference in its entirety.

The active jack 18 of FIG. 2 is provided with an indicator such as a light-emitting diode (LED) 24, which in one embodiment emits light toward a light pipe 26. The light pipe 26, in turn, emits light at two ends 28 and 30, allowing light from the LED 24 to be viewed from either side of the active jack 18. The active jack 18 accepts a plug 32 of the patchcord 16.

Turning now to FIG. 3, a cross-connect cabling system 34 is shown. A switch 12 is connected to other network components via a network connection (not shown) and via a patch cord 16 to a first patch panel 36. The first patch panel 36 is, in turn, connected to a second patch panel 38 by a patch cord 16. The second patch panel 38 is connected to an active communication jack 22 via horizontal cabling 20.

Turning now to FIG. 4, a communications installation and maintenance system 40 is shown in which an installation assistant device 42, such as a portable personal computer, is connected to a communication network at a switch 12.

According to some embodiments of the present invention, an active jack installation system includes a combination of active patch panel communication jacks 18 and active communication jacks 22 at network destinations, which are used to facilitate documentation systems, installation guide and monitoring systems, and revision guide and monitoring systems to provide increased functionality in the installation, monitoring, and revision of communications cabling systems. Systems and methods according to the present invention may replace the need for scanners, hard-wired LEDs, and their sources, and special patch cords which are used in some installation, monitoring, and revising systems.

Active jacks in systems according to the present invention respond to queries with their identification information, allowing systems according to the invention to know which circuit paths active jacks are located on. Because active jacks according to the present invention allow physical location information to be stored—for example, when the jacks are physically installed as part of a network infrastructure—an installer or reviser may be provided with information on the required cable length for a particular cable installation or revising step.

Every installer and/or revisor may be equipped with an installation assistant device 42 (shown in FIG. 4), such as a portable PC, to be connected to the network, allowing for two-way communication between the installer and the system. According to some embodiments, the system provides each work order with installation or revision instructions to an installer or revisor who tells the system when he starts and when he has completed a work order. In some embodiments, the system will not accept a completion unless the system agrees by its documentation of the network that the installation or revision step has been accomplished as ordered. Work orders may specify cord lengths where applicable.

Patch panels according to some embodiments of the present invention are provided with a number of active twisted-pair patch panel communication jacks (which may be termed “P-Jack patch panels”), with each jack including an LED that can be controlled by the active jack in response to a “command message” from the network. As shown in FIG. 2, the LED is preferably visible from both the front and back of the active jack. The LEDs are used to provide visual installation and revising cues to an installer. One example of LED codes is:

| LED Status | Command |
|---|---|
| ON | CONNECT HERE |
| BLINK SLOWLY | DISCONNECT HERE |
| BLINK RAPIDLY | CONNECTION TO PORT IS CORRECT |

In this example, when an installation or revision is correctly completed, the system will communicate this and the associated LED or LEDs will blink rapidly until the installer turns them offby telling the system that he has completed the associated work order.

When an installation or revision is incorrectly completed, the system will communicate the entire problem and operate the associated LEDs, provided there is a network connection to the associated active jacks. If there is not a network connection to the associated jacks, the system will communicate what it can deduce (for example via the installation assistant device 42) and operate the appropriate LEDs of the associated jacks which are connected to the network.

In either interconnect or cross-connect applications, connection of cables from a switch to a patch panel may be aided by an LED. When an installer is instructed to connect a particular cable from a switch to a particular jack on a patch panel, the installer tells the system he is starting this process. If the process is correctly completed, according to the LED codes outlined above, the LED associated with the patch panel port blinks rapidly until the installer turns it off from his PC (or other installation assistant device 42).

If, however, the installer connects the wrong switch port to the correct patch panel jack or connects the correct switch port to the wrong patch panel jack, the LED on that patch panel port blinks slowly and the installation assistant device 42 tells the installer the various possible sources of the problem. In addition to a cabling error, the physical location of the P-Jack could have been incorrectly recorded when it was installed. When the connection is removed, the LED light goes out.

After the above is completed, if the installation is a cross-connect configuration, as shown in FIG. 3, a similar procedure is utilized to guide the installation of each patch cord. In this procedure, the system turns on the appropriate LED on the patch panel 36 closest to the switch 12 when the installer tells the system he is starting this process. If the installer correctly completes the process, the appropriate LEDs on both patch panels blink rapidly until the installer turns them off with his installation assistant device 42.

If, however, one end of the patch cord was connected to an incorrect port, the system tells the installer the various possible sources of the problem and the LED associated with the incorrect port will blink slowly until that end of the patch cord is removed.

If both ends of the patch cord were connected to incorrect ports, the system tells the installer the various possible sources of the problem and the LEDs associated with both ports would blink slowly. In this case, the installer should first remove the patch cord connection which is farthest from the switch and the associated LED will go out. He should then remove the other connection of the patch cord and tell the system he has completed this and the other LED will go out.

After the above is completed, if the destination path to an active jack 22 (which may be termed an “A-Jack”) is complete, except for the connection of the horizontal cable 20 to the associated patch panel port, a similar procedure can be used to guide the connection of the horizontal cable 20 to the associated patch panel port. In this procedure, the system turns on the appropriate LED on the associated patch panel and makes it blink rapidly if the installation results in the correct A-Jack being connected to the correct network path. This step applies to systems such as those shown in FIGS. 1 and 3.

The installer would turn off the LED with the installation assistant device 42. If the horizontal cable 20 is connected to the wrong A-Jack and/or the wrong P-Jack, the system will communicate the various possible sources of the problem and the associated LED will blink slowly until the connection is removed.

Steps for revision of a cross-connect installation may utilize a similar system, whose steps are summarized below.

The following steps may be used to facilitate removal of a patch cord:
1. LED for the port farthest from the source blinks slowly.
2. LED for the port farthest from the source goes out when the plug has been removed.
3. LED for the port closest to the source blinks slowly.
4. LED for the port closest to the source goes out when the installer tells the system the plug has been removed.

The following steps maybe used to facilitate the transfer of one end of a patch cord:
1. Instruction includes removal followed by addition, or if patch cord is a suitable length, one end is transferred from one port to another.
2. The removal port LED blinks slowly until the plug is removed.
3. If the addition port is closest to the switch, the port LED goes on and changes to fast blinking if the plug is properly installed.
4. If the installation is incorrect, the port LED will blink slowly.
5. If the addition port is farthest from the switch, no LED goes on until the plug is installed in a farthest port. If the installation is correct, the farthest port LED will blink rapidly.
6. If the installation is incorrect the farthest port LED will blink slowly.
7. When the transfer is correctly completed, the revisor turns off the blinking LED with the PC.

Revision of an interconnect installation may utilize a similar system:
1. The system directs the removal of a cable connected to the front or back of a specified P-Jack and the associated LED blinks slowly until this is completed.
2. The system directs the connection of a cable to the front or back of a specified P-Jack and the associated LED blinks rapidly when this is correctly completed.

After a network has been completely installed and one element of the documentation changes, the system can immediately define the segment that has changed and communicate information about the change.

While particular embodiments and applications of the present invention have been illustrated and described, it is to be understood that the invention is not limited to the precise construction and compositions disclosed herein. For example, different blinking patterns or types of indicators may be employed in systems and methods according to the present invention. Various other modifications, changes, and variations may be apparent from the foregoing descriptions without departing from the spirit and scope of the invention as defined in the appended claims.

What is claimed is:

1. A method for implementing a planned change to network cabling in a communication network, comprising:
(a) displaying a first visual cue upon a network connected device to instruct a cable installer to do one of connecting and disconnecting a cable from an identified equipment port affected by the planned change;
(b) determining whether the planned change is implemented correctly; and
(c) displaying a second visual cue upon the network connected device that informs the cable installer whether the planned change has been correctly implemented,
wherein displaying visual cues and determining whether the planned change is implemented correctly are based, at least in part, upon communication with an active communication jack.

2. The method of claim 1, wherein at least one of the displayed first and second visual cues is an illuminated light emitting device associated with a port on the network connected device.

3. The method of claim 1, wherein at least one of the displayed first and second visual cues is presented upon an installation tool connected to the communication network.

4. The method of claim 1, wherein (b) further includes:
(b.1) determining whether the planned change is implemented correctly based, at least in part, upon stored documentation of the communication network.

5. The method of claim 1, further comprising:
(d) presenting the defined planned change to the cable installer for selection; and
(e) monitoring implementation of the planned change upon selection by the cable installer.

6. The method of claim 1, further comprising:
(d) receiving an indication from a cable installer that the cable installer is starting implementation of the planned change; and
(e) monitoring implementation of the planned change upon receiving the start indication from the cable installer.

7. The method of claim 1, further comprising deactivating the visual cues in response to at least one of:
a cable installer indicating that the planned change is complete;
determining that the planned change is implemented correctly;
expiration of a predetermined delay; and removal of a cable connection.
